(19) United States
(12) Patent Application Publication
(10) Pub. No.: US 2024/0021922 A1
(43) Pub. Date: Jan. 18, 2024

(54) HIGH AUTONOMY ZINC BATTERIES

(71) Applicant: FUNDACIÓN CIDETEC, DONOSTIA-SAN SEBASTIÁN (ES)

(72) Inventors: Jose Alberto BLÁZQUEZ MARTIN, DONOSTIA-SAN SEBASTIÁN (ES); Aroa RAMOS MAINAR, DONOSTIA-SAN SEBASTIÁN (AD); Idoia URDAMPILLETA GONZALEZ, DONOSTIA-SAN SEBASTIÁN (ES)

(21) Appl. No.: 18/031,825

(22) PCT Filed: Sep. 15, 2021
(86) PCT No.: PCT/EP2021/075400

§ 371 Date: Apr. 13, 2023

(30) Foreign Application Priority Data
Oct. 30, 2020 (AD) 20382949.4

(51) Int. Cl. H01M 12/06; H01M 4/42; H01M 4/86; H01M 50/46

(52) U.S. Cl. CPC H01M 12/065; H01M 4/42; H01M 4/8615; H01M 50/46; H01M 2004/027

(57) ABSTRACT

It is provided a secondary zinc-air battery comprising at least two secondary zinc-air electrochemical cells, each cell comprising an air cathode that is a bifunctional air electrode (BAE); a zinc-containing anode; a free electrolyte contained in a reservoir; and a first and a second separators; wherein the zinc-containing anode is disposed between the BAE and the free electrolyte, and is separated from the BAE by the first separator and separated from the free electrolyte by the second separator, and wherein the at least two cells are assembled together in such a way that a unique electrolyte reservoir containing the free electrolyte is placed between at least two zinc anodes and thus is shared by the at least two secondary zinc-air electrochemical cells.

This application claims the benefit of the European Patent Application EP20382949.4 filed on Oct. 30, 2020.

### TECHNICAL FIELD

The present disclosure relates to the field of rechargeable batteries. In particular, it relates to an aqueous secondary zinc-air battery having a particular cell configuration, as well as to a process for its preparation.

### BACKGROUND ART

Secondary zinc-air batteries have a high energy density compared to other zinc anode batteries due to its free and unlimited oxygen supply from the ambient air. However, since the air electrode must be sufficiently porous to permit the air passage, zinc-air battery is susceptible to water loss and hence electrolyte drying out, this giving rise to a low reversibility.

Several challenges are being faced in the state of the art to improve secondary zinc-air batteries. Although cell drying is a well-known challenge reported in the state of the art, major efforts are oriented to material development without providing any cell engineering solution, which is critical to achieve a viable secondary zinc-air battery.

In order to be viable for practical applications, secondary zinc-air batteries require the reduction of non-active materials such as the electrolyte system. However, once the electrolyte volume is reduced, the cell drying becomes a critical problem, as secondary zinc-air battery is an open system in contact with the surrounding air. Cell drying promotes the inactivation of zinc active material particles, what considerably reduces the reversibility and the electrochemical properties of the secondary zinc-air battery.

Different approaches have been followed in the prior art for avoiding cell drying, such as the electrolyte modification (e.g. solid electrolyte), the utilization of a zinc paste (containing a gelling agent presenting an electrolyte immobilizing ability), or the incorporation of different selective membranes or separators.

An alternative also studied in order to avoid the drying of the system is the incorporation of an electrolyte reservoir placed between the cathode and the anode. However, when a full system of a secondary zinc air battery is assembled, the energy of the system is reduced.

EP2528156 discloses a secondary air battery comprising a power generation body comprising a laminate in which a zinc negative electrode, a separator, a positive electrode (which can be a bifunctional air cathode) and an oxygen diffusion membrane are laminated in this order, and an electrolyte is in contact with the negative electrode, the separator and the positive electrode. The anode is placed between the electrolyte and the separator.

EP0518407 discloses a half-cell which comprises a zinc-containing anode, wherein an electrolyte reservoir is disposed between the cathode and the zinc-containing anode.

US2004038090 discloses a metal air electrochemical cells stacks, wherein the cathode may be bifunctional, and inter-cell layers serving as a passageway for introducing electrolyte.

Lang, X., Hu, Z., & Wang, C. (2020). “Bifunctional air electrodes for flexible rechargeable Zn-air batteries”, Chinese Chemical Letters, doi:10.1016/j.cclet.2020.10.005, discloses flexible rechargeable Zn-air batteries comprising bifunctional oxygen reduction reaction and oxygen reaction electrocatalysts.

US2002142203 discloses an anode chamber for a metal air electrochemical cell including the anode chamber and a cathode structure, the anode chamber comprising a housing configured and dimensioned to hold a quantity of anode paste including consumable metal particles, a gelling agent, and a base, and a separator attached to at least one surface of the housing, wherein the anode chamber is configured and dimensioned for removal and insertion into the cathode structure.

In spite of the above, there is still a need of further solutions for providing secondary zinc-air batteries with improved cycling performance and energy.

### SUMMARY OF INVENTION

The inventors have found a cell configuration that delays the problem of the reversibility of secondary zinc-air batteries and, additionally, improves the energy density of the system. The cell configuration of the present disclosure allows optimizing the performance of a secondary zinc-air battery by means of placing the electrolyte reservoir in an optimal location, close to the zinc anode and away from the air electrode. Although a priori it might seem that this approach would not assure the flow of the electrolyte from behind the zinc anode to the bifunctional air electrode, surprisingly, electrolyte drying is reduced and, as a consequence, an improved reversibility is obtained compared with cell configurations disclosed in the prior art. In addition, the cell configuration here proposed reduces the electrolyte reservoir weight and volume contribution and therefore it allows the increase of the energy density.

It is disclosed a secondary zinc-air electrochemical cell comprising:
an air cathode, which is a bifunctional air electrode (BAE);
a zinc-containing anode comprising a zinc active material and an electrolyte;
at least one first separator disposed between the BAE and the zinc-containing anode;
a free electrolyte contained in a reservoir; and
at least one second separator disposed between the zinc-containing anode and the free electrolyte;
   wherein the zinc-containing anode is disposed between the BAE and the free electrolyte, and is separated from the BAE by the at least one first separator and separated from the free electrolyte by the at least one second separator.

Advantageously, the electrolyte reservoir placed next to the zinc-containing anode (both separated by a separator) and away from the BAE supplies electrolyte to the zinc-containing anode as the electrolyte evaporates, thus preventing the flooding of the BAE as opposed to a configuration wherein the free electrolyte is placed between the zinc-containing anode and the BAE. Free electrolyte close to the BAE is avoided and, consequently, the evaporation is delayed and the durability of the cell is increased.

In order to be viable for practical applications, secondary zinc-air batteries require the reduction of non-active materials such as the electrolyte system.

Thus, it is understood that the free electrolyte contained in a reservoir and the BAE are not next to each other, but the zinc-containing anode is disposed between the BAE and the free electrolyte. It is also understood that no free electrolyte contained in a reservoir is disposed between the BAE and the zinc-containing anode.

It is also disclosed a secondary zinc-air electrochemical cell comprising only one free electrolyte contained in a reservoir, namely a secondary zinc-air electrochemical cell comprising:
an air cathode, which is a bifunctional air electrode (BAE);
a zinc-containing anode comprising a zinc active material and an electrolyte;
at least one first separator disposed between the BAE and the zinc-containing anode;
a free electrolyte contained in a reservoir; and
at least one second separator disposed between the zinc-containing anode and the free electrolyte;
   wherein the zinc-containing anode is disposed between the BAE and the free electrolyte, and is separated from the BAE by the at least one first separator and separated from the free electrolyte by the at least one second separator, wherein the secondary zinc-air electrochemical cell comprises only one free electrolyte contained in a reservoir, namely only one reservoir.
It is also disclosed, a secondary zinc-air electrochemical cell consisting of:
an air cathode, which is a bifunctional air electrode (BAE);
a zinc-containing anode comprising a zinc active material and an electrolyte;
at least one first separator disposed between the BAE and the zinc-containing anode;
a free electrolyte contained in a reservoir; and
at least one second separator disposed between the zinc-containing anode and the free electrolyte;
   wherein the zinc-containing anode is disposed between the BAE and the free electrolyte, and is separated from the BAE by the at least one first separator and separated from the free electrolyte by the at least one second separator.

Advantageously, when assembling at least two secondary zinc-air cells as disclosed herein above and below, the reservoir containing the free electrolyte can be shared by two secondary zinc-air electrochemical cells and, thus, a secondary zinc-air battery with a reduced total weight and volume can be obtained, and hence, the specific energy of the technology is improved.

Thus, an aspect of the present disclosure relates to a secondary zinc-air battery comprising at least two secondary zinc-air electrochemical cells as disclosed herein above, wherein the at least two cells are assembled together in such a way that a unique electrolyte reservoir is placed between at least two zinc anodes and thus is shared by the at least two secondary zinc-air electrochemical cells.

### BRIEF DESCRIPTION OF DRAWINGS

FIG. 1 depicts an electrochemical half-cell configuration of to the prior art wherein a liquid electrolyte is between the bifunctional air electrode (BAE) and the zinc anode (a) before cycling and, (b) after a number of hours (XX) cycling. This half-cell configuration (see FIG. 1 (a)), which is composed by a high volume of electrolyte system, is generally used for the validation of material development, as the evaporation of the electrolyte is not a real problem during cycling since BAE and the zinc anode are still in contact with the electrolyte system as reflected in FIG. 1 (b). However, the incorporation of a high volume of electrolyte results in a secondary zinc-air battery with very low specific energy, which is not viable for practical applications.

FIG. 2 depicts a reduced electrolyte based cell configuration (a) before cycling and, (b) after XX h cycling, wherein it is shown that cell drying promotes the inactivation of zinc active material particles.

FIG. 3 depicts a secondary zinc-air electrochemical cell according to the present disclosure (comprising a free electrolyte reservoir placed close to zinc anode and away from the BAE, i.e. wherein the zinc-containing anode is between the free electrolyte reservoir and the BAE and separated therefrom by separators) (a) before cycling and, (b) after XX h cycling, wherein 1 is a bifunctional air electrode (BAE), 2 is a first separator, 3 is a zinc-containing anode, 4 is a second separator, and 5 is a free electrolyte in a reservoir.

FIG. 4 depicts secondary zinc-air battery cells having the following configurations: (A) without any electrolyte reservoir, (B) with an electrolyte reservoir placed between the zinc-containing and the BAE electrodes and, (C) with an electrolyte reservoir placed close to the zinc anode and away from the BAE (configuration of the present invention), (D) with an electrolyte reservoir placed between the zinc-containing and the BAE electrodes and an electrolyte reservoir placed close to the zinc anode and away from the BAE.

FIG. 5 shows the results of reversibility tests carried out with secondary zinc-air battery cells having configurations A, B, C, and D depicted in FIG. 4.

FIG. 6 depicts a typical secondary zinc-air battery (configuration B). In the secondary zinc-air cell (configuration B) an electrolyte reservoir is placed between the positive (bifunctional air cathode) and the negative (zinc anode) electrodes. The construction of a secondary zinc-air battery (two cathodes and two anodes) from two of the mentioned cells requires two electrolyte reservoirs.

FIG. 7 depicts a battery having two secondary zinc-air cells with configuration C according to the present disclosure.

FIG. 8 shows the charge/discharge profiles of a secondary zinc-air battery from cell configuration B according to the prior art and of a secondary zinc-air battery from cell configuration C of the present disclosure.

FIG. 9 shows improvement of specific energy of a secondary zinc-air battery from cell configuration C of the present disclosure.

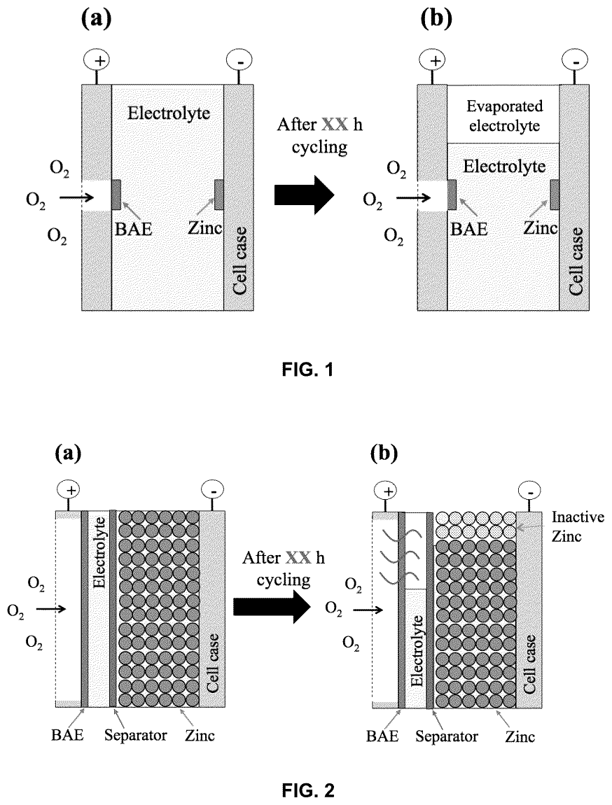

### DETAILED DESCRIPTION OF THE INVENTION

The term “paste”, as used herein, refers to a viscous water-based dispersion of particles.

The term “free electrolyte”, as used herein, relates to the electrolyte that is not forming part of a mixture, such as in the zinc-containing anode, namely to the electrolyte that is contained in a reservoir.

Within the scope of the present disclosure, the term “saturated solution” or “saturation” related to the concentration of a compound (such as ZnO) in an aqueous solution means a solution containing a concentration of the compound that is equal to the maximum amount of compound that can be dissolved at a specific temperature and pH. Particularly, the saturation concentration of a compound is at room temperature (taken as being around 20° C., typically 20 to 23° C.).

As used herein, the indefinite articles “a” and “an” are synonymous with “at least one” or “one or more”. Unless indicated otherwise, definite articles used herein, such as “the”, also include the plural of the noun.

As mentioned above, an object of the present disclosure is a secondary zinc-air battery comprising at least two secondary zinc-air electrochemical cells, each cell comprising a bifunctional air electrode (BAE); a zinc-containing anode; a free electrolyte contained in a reservoir; at least one first separator and at least one second separator, which can be equal or different; the zinc-containing anode being disposed between the BAE and the free electrolyte, and being separated from the BAE by the at least one first separator and from the free electrolyte by the at least one second separator, and wherein the at least two cells are assembled together in such a way that a unique electrolyte reservoir is shared by the at least two secondary zinc-air electrochemical cells.

In a particular embodiment, the secondary zinc-air battery comprises only one reservoir.

The electrolyte in the zinc-containing anode can be equal or different to the free electrolyte in the reservoir.

In another embodiment, optionally in combination with one or more features of the particular embodiments defined above, the weight ratio of free electrolyte in the reservoir:zinc active material is from 0.05:1 to 1:1.

In case at least one of the cells comprises more than one first separators and/or one or more second separators, the first separators can be equal or different, the second separators can be equal or different, and the first and second separators can also be equal or different.

It should be also noticed that this approach is compatible with different formulations of zinc anode, BAE and/or electrolyte systems and, even, with different separators. The separators between the zinc anode and electrolyte tank, and between the zinc anode and BAE are placed in order to avoid physical/chemical migration of the components of the zinc-containing anode.

A separator commonly used in the preparation of zinc-air batteries can be used. Examples of separators include, without being limited to, a glass fibre separator, polymeric materials such as polypropylene (PP), polyethylene (PE), poly(vinyl alcohol) (PVA), polyacrylic acid (PAA), polyetherimide (PEI), polyamide (PA), and combinations thereof such as Celgard® (e.g. 5550). Selective anion-exchange membranes could also be used as separators. Advantageously, selective anion-exchange membranes favor the crossing of desirable species such as OH⁺ ions to the BAE, while disfavor the crossing of water, Zn(OH)₄²⁺ or other ions coming from electrolyte additives (such as CO₃²⁺, K⁺), thus avoiding cell drying or BAE poisoning.

### Electrolyte (Aqueous Alkaline Electrolyte System)

In the zinc-air battery of the present disclosure, electrolytes commonly used in the preparation of zinc-air batteries can be used.

ZnO, KF and K₂CO₃ have been reported as effective electrolyte additives to improve the reversibility of nickel-zinc systems. The electrochemical reactions that take place in this technology at the anodic level are the same as in the zinc-air technology. The mentioned additives reduce the high dissolution of zinc in the aqueous alkaline electrolyte system, thus avoiding to some extent the electrode shape change and dendrite growth. Besides, although it is known that low concentrations of KOH and high concentrations of KF and K₂CO₃ are preferred to improve the electrochemical performance of zinc anodes, bifunctional air electrodes used in zinc-air technology require additive free and high KOH concentration based electrolyte formulation. Consequently, a proper formulation for secondary zinc-air battery requires a compromise between both electrodes.

Accordingly, in an embodiment, optionally in combination with one or more features of the particular embodiments defined above, the electrolyte formulation used in the secondary zinc-air battery of the present disclosure is an aqueous solution comprising from 0.1 M to 15 M KOH, from 0 M to 6 M KF, from 0 M to 6 M K₂CO₃, and from 0 M ZnO to saturation with ZnO. In an example, the electrolyte formulation is based on an aqueous solution comprising about 7 M KOH, about 1.4 M KF, and about 1.4 M K₂CO₃, and saturated with ZnO.

### Zinc-Containing Anode

In the zinc-air cell of the present disclosure, zinc-containing anodes commonly used in the preparation of zinc-air batteries can be used.

The zinc active material of the zinc-containing anode usually comprises metallic zinc powder and, optionally, ZnO. The addition of ZnO provides reserves of discharge product and deals with another critical issue, that is the control of anode volume changes produced during battery testing due to molar density differences (9.15 cm³ mol⁻¹ vs. 14.5 cm³ mol⁻¹), what generate internal pressures in the cell. Thus, the initial addition of ZnO to the porous zinc electrode allows accommodating part of this expected volume change.

Thus, in an embodiment, optionally in combination with one or more features of the particular embodiments defined above, the zinc active material is a mixture of metallic zinc powder and ZnO. Optionally, the zinc-containing another further comprises a gelling agent, a binder, or both of them. Examples of gelling agents include, without being limited to, carboxymethyl cellulose, carbopol, and acrylate polymers. Examples of binders include, without being limited to, polytetrafluoroethylene (PTFE) and polyethylene (PE).

In an embodiment, optionally in combination with one or more features of the particular embodiments defined above, the zinc-containing anode is a zinc paste comprising from 50 wt. % to 90 wt. % of zinc, from 10 wt. % to 50 wt. % of ZnO, from 10 wt. % to 40 wt. % of the electrolyte formulation defined above and from 0.1 wt. % to 10 wt. % of carboxymethyl cellulose as gelling agent.

Particularly, the zinc powder contains bismuth traces, indium traces, aluminum traces, or mixtures thereof, what promote an increased zinc corrosion resistance. In a particular example, the zinc-containing anode consists of about 46.28 wt. % of zinc, about 24.12 wt. % of ZnO, about 28.2 wt. % of the electrolyte system defined above, and about 1.4 wt % of carboxymethyl cellulose. Particularly, the zinc powder contains bismuth, indium and aluminum traces.

### Bifunctional Air Electrode (BAE)

In the zinc-air battery of the present disclosure, BAEs commonly used in the preparation of zinc-air batteries can be used. To improve the stability of the BAE, a carbon free electrode was proposed. In an example, a BAE was prepared by mixing 39 wt. % or NiCo₂O₄, 46 wt. % of Ni and 15 wt. % of PTFE, and pressing the mixture against a stainless steel mesh.

As described above one or more secondary zinc-air electrochemical cells can be packaged in a container in order to get a secondary zinc-air battery.

It is also disclosed a process for the preparation of a secondary zinc-air electrochemical cell as defined above, the process comprising assembling a BAE as defined above, a zinc-containing anode as defined above, a first and a second separator as defined above, and a free electrolyte as defined above, wherein the free electrolyte is contained in a reservoir; in such a way that the zinc-containing anode is disposed between the BAE and the free electrolyte and is separated from the BAE by the first separator and separated from the free electrolyte by the second separator.

Thus, in the process disclosed above, the free electrolyte contained in a reservoir is not disposed between the BAE and the zinc-containing anode.

Cell assembling refers to the preparation of cases, gaskets, current collectors, an electrolyte reservoir, and separators with the desired geometrical area, and wherein the cathode, anode (such as a zinc paste) and electrolyte are placed. The electrolyte reservoir can contains an opening for electrolyte filling once the cell is assembled. In an example, a (second) separator and an anodic current collector are placed on top of the electrolyte reservoir. After that, a zinc paste is applied on top of current collector and adjusted to the gasket with desired thickness. Then, a (first) separator is embedded on the electrolyte and placed on top of the zinc anode. Finally, a bifunctional air electrode is placed on top and the electrochemical cell is closed with adjusted pressure to the dimensions and geometry of the battery.

In order to manufacture the secondary zinc-air battery of the present disclosure, at least two cells are assembled together in such a way that a unique electrolyte reservoir is placed between at least two zinc anodes and thus, it is shared by at least two secondary zinc-air electrochemical cells. The obtained battery can be manufactured according to different cell geometries such as planar.

All the embodiments disclosed herein for the secondary zinc-containing anode, i.e. related with the composition of its components, also apply for the process for the preparation of the cell and of the battery.

Throughout the description and claims the word “comprise” encompasses the case of “consisting of”. The following examples and drawings are provided by way of illustration, and they are not intended to be limiting of the present disclosure.

### EXAMPLES

### Reference Example 1—Cell and preparation of the cell components

### Preparation of the Electrolyte

An electrolyte formulation was prepared by first preparing an aqueous solution containing 7 M of KOH (Sigma-Aldrich, 85% purity), 1.4 M of KF (Sigma-Aldrich, 99% purity) and 1.4 M of K₂CO₃ (Sigma-Aldrich, 99% purity). Finally, the obtained solution was saturated with

ZnO (Sigma-Aldrich, 99% purity).

### Preparation of the Secondary Zinc-Containing Anode

A zinc paste formulation was prepared by mixing 46.28 wt. % zinc (EverZinc, BIA), 24.12 wt. % ZnO (EverZinc), 28.2 wt. % of the electrolyte formulation described above, and 1.4 wt. % carboxymethyl cellulose (CMC, Cekol) as gelling agent. It has to be pointed out that metallic zinc powder from EverZinc contains bismuth, indium and aluminum traces which promote an increased zinc corrosion resistance.

### Preparation of the Bifunctional Air Electrode

A bifunctional air electrode, which was a carbon free electrode, was prepared by mixing 39 wt. % NiCo₂O₄ (NCO, Cerpotech), 46 wt. % Ni (StremChem, 3-7 μm) and 15 wt. % PTFE (GoodFellow, 6-9 μm). The mixture was pressed against a stainless steel mesh (Haver &

Boecker) applying 1 ton during 2 min where the resulting mixture loading was 126 mg cm⁻².

### Cell Configuration

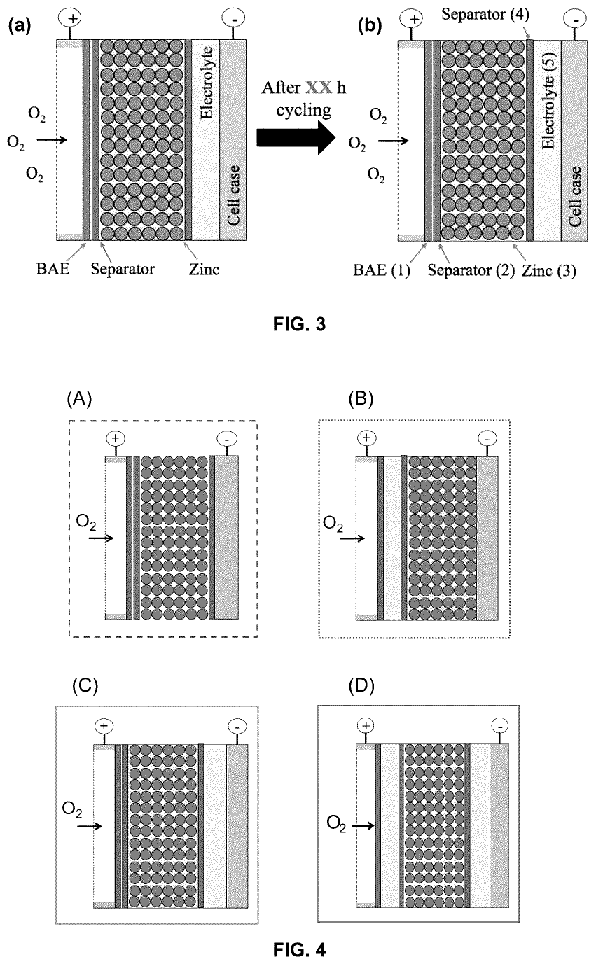

A secondary zinc-air cell comprising an electrolyte, a zinc-containing anode and bifunctional air electrode, and having the configuration as defined above (configuration C; see FIG. 3 and FIG. 4, (C)) was assembled as described above.

### Comparative Examples 1, 2, and 3

For comparative purposed, a secondary zinc-air cell with configuration A (see FIG. 4, (A); Comparative Example 1), i.e. similarly as in Example 1 but without free electrolyte reservoir, a secondary zinc-air cell with configuration B (see FIG. 4, (B); Comparative Example 2), i.e. similarly as in Example 1 but with a free electrolyte reservoir between the BAE and the zinc-containing anode, and a secondary zinc-air cell design D (see FIG. 4 (D); Comparative Example 3), i.e. similarly as in Example 1 but with an additional electrolyte reservoir between the BAE and the zinc-containing anode, where also assembled.

### Reference Example 2—Electrochemical Characterization

Electrochemical characterization of the secondary zinc-air cells of Example 1 and

Comparative examples 1, 2 and 3 was performed using a BaSyTec Battery Test System. Electrochemical performance of the cells was evaluated at 2 mA cm⁻².

It is well known that in secondary zinc-based technologies the specific capacities should be controlled in order to improve the cycling performance. On the contrary, if too high specific capacity is obtained from the zinc anode, the reversibility of the system will be reduced due to the abovementioned anodic volume changes, zinc passivation and electrolyte loss due to the break-up of the gelling agent losing its electrolyte immobilizing ability. Thus, for the purpose of improving the cycling performance, cells were evaluated at 20% of practical capacity using a cut-off voltage of 0.95 V and 2.1 V.

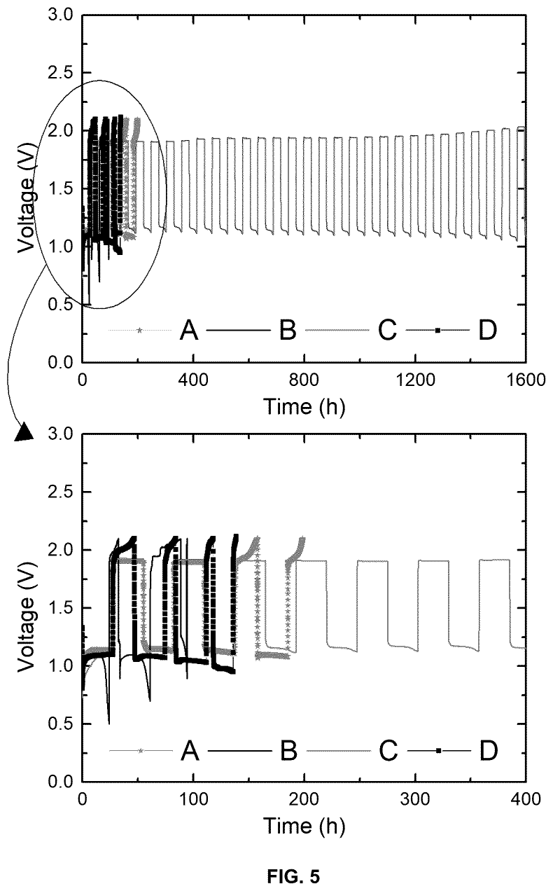

As it is shown in FIG. 5, the reversibility of cell configuration A is limited to 200 h cycling, and even worse results are obtained when including the reservoir between zinc and the BAE (cell configuration B) or additional electrolyte reservoir to cell design C between zinc and BAE (cell design D). Surprisingly, with the cell configuration C according to the present disclosure a very high reversibility is obtained (more than 1800 h).

The main difference between cell configurations A, B and D is the electrolyte reservoir. The electrolyte system in cell configuration A is part of the zinc paste structure, which immobilizes to some extent the electrolyte system. Cell configuration B, besides having electrolyte included in the zinc paste, also presents free electrolyte system (in a reservoir) between the zinc-containing anode and the BAE, what makes the electrolyte more susceptible to be evaporated due to its proximity to the open side of the cell. Finally, cell design D, besides having electrolyte included in the zinc paste, presents two electrolyte reservoirs; (i) between zinc-containing anode and BAE and, (ii) close to zinc anode as cell design C does. It was observed that when the electrolyte reservoir is between zinc-containing anode and the BAE the later can be damaged (by flooding) due to the long-term cycling conditions.

The cell configuration C of the present disclosure presents long-term reversibility (more than 1800 h in this example). Since the free electrolyte is not placed close to the open BAE, BAE flooding is more impeded. At the same time, the free electrolyte reservoir can fuel the zinc-containing anode as the electrolyte contained therein dries. All in all, the durability of the cell according to the present disclosure (configuration C) is significantly higher compared both with durability of cell of configurations A, B and D.

Example 3 and Comparative Example 4—Assembled secondary zinc-air batteries

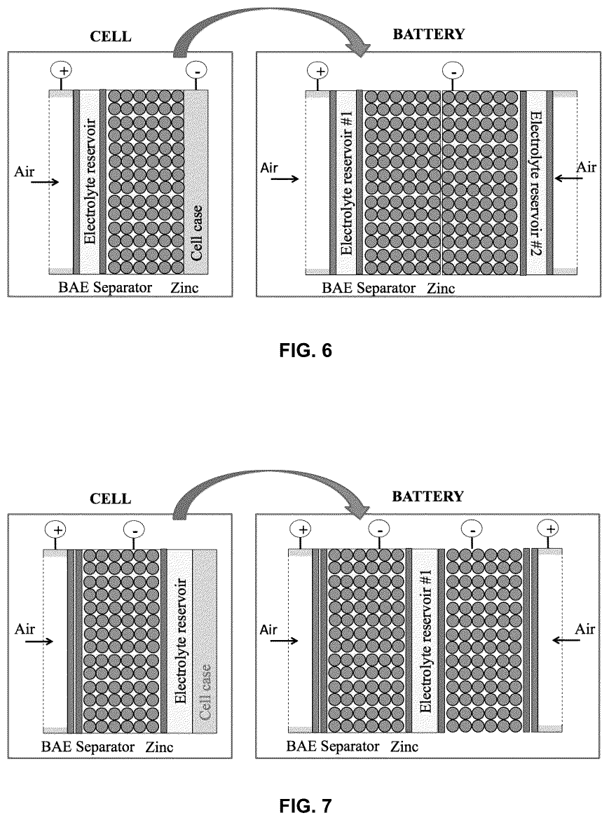

For comparative purposed, two secondary zinc-air cells with configuration B based on the state of the art cell configuration (see FIG. 4 (B)) were assembled as shown in FIG. 6 in order to obtain a cell configuration B based secondary zinc-air battery (Comparative Example 4), and two secondary zinc-air cells with configuration C according to the present disclosure (see FIG. 4 (C); Reference Example 1) where assembled in order to obtain the cell configuration C based secondary zinc-air battery of the invention as shown in FIG. 7. The main difference between the batteries obtained from cells with configuration B and from cells with configuration C is the electrolyte reservoir, that is while the battery from cells with configuration B contains two electrolyte reservoirs placed between each positive and negative electrodes, the battery from cells with configuration C of the invention contains a unique electrolyte reservoir placed between the two zinc anodes.

The electrolyte reservoir weight:zinc active material (Zn/ZnO) ratio in the zinc-air cells is 1:1 for both, cell configuration B and C (FIG. 4). Since the battery from cell configuration C of the invention (FIG. 7) just includes one electrolyte reservoir instead two, the electrolyte reservoir weight:zinc active material ratio was 0.5:1.

### Electrochemical Characterization

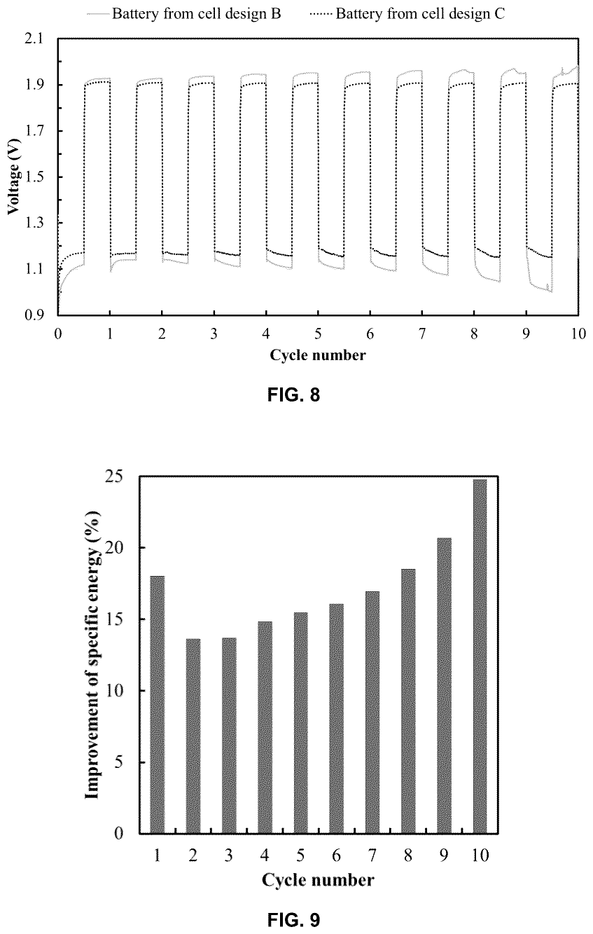

Electrochemical characterization of the secondary zinc-air batteries of Example 3 and Comparative Example 4 was performed using a BaSyTec Battery Test System. Electrochemical performance of the batteries was evaluated at 2 mA cm⁻² during 10 charge/discharge cycles. The results, i.e., the charge/discharge profiles of secondary zinc-air batteries from assembled cell configurations B and C, are shown in FIG. 8. It is appreciable an increased cell polarization of cell configuration B based secondary zinc-air battery during cycling. However, charge/discharge profile of cell configuration C based secondary zinc-air battery is stable during the cycling.

The improvement of specific energy of cell configuration C based secondary zinc-air battery configuration is shown in FIG. 9, being 12-20% greater than cell configuration B based secondary zinc-air battery. In conclusion, the cell configuration C based secondary zinc-air battery of the present invention having a unique electrolyte reservoir provides an electrochemically stable secondary zinc-air battery with improved specific energy.

### Cited References

1. EP2528156;
2. EP0518407;
3. US2004038090;
4. Lang, X., Hu, Z., & Wang, C. (2020). “Bifunctional air electrodes for flexible rechargeable Zn-air batteries”, Chinese Chemical Letters, doi:10.1016/j.cclet.2020.10.005;
5. US2002142203.

For reasons of completeness, various aspects of the invention are set out in the following numbered clauses:

1. A secondary zinc-air battery comprising at least two secondary zinc-air electrochemical cells, each cell comprising:
an air cathode, which is a bifunctional air electrode (BAE);
a zinc-containing anode comprising a zinc active material and an electrolyte;
at least one first separator;
a free electrolyte contained in a reservoir; and
at least one second separator;
   wherein the zinc-containing anode is disposed between the BAE and the free electrolyte, and is separated from the BAE by the at least one first separator and separated from the free electrolyte by the at least one second separator, and
   wherein the reservoir containing the free electrolyte is shared by two secondary zinc-air electrochemical cells.

2. The secondary zinc-air battery of clause 1, wherein the weight ratio of free electrolyte in the reservoir:zinc active material is from 0.05:1 to 1:1.

3. The secondary zinc-air electrochemical battery of clause 1 or 2, wherein the zinc active material is a mixture of metallic zinc powder and ZnO.

4. The secondary zinc-air electrochemical battery of clause 1 or 3, wherein the electrolyte is an aqueous solution comprising from 0.1 M to 15 M KOH, from 0 M to 6 M KF, from 0 M to 6 M K₂CO₃, and from 0 M ZnO to saturation with ZnO.

15 5. The secondary zinc-air electrochemical battery of clause 1 or 3, wherein the electrolyte is an aqueous solution comprising about 7 M of KOH, about 1.4 M of KF, about 1.4 M of K₂CO₃, and ZnO until saturation.

6. The secondary zinc-air electrochemical battery of any one of clauses 1 to 5, wherein 20 the zinc-containing anode is a zinc paste comprising from 50 wt. % to 90 wt. % of zinc powder, from 10 wt. % to 50 wt. % of ZnO, from 10 wt. % to 40 wt. % of the electrolyte, and from 0.1 wt. % to 10 wt. % of carboxymethyl cellulose.

7. The secondary zinc-air electrochemical battery of clauses 6, wherein the zinc powder contains bismuth traces, indium traces, aluminum traces, or mixtures thereof.

8. The secondary zinc-air electrochemical battery of clauses 6 or 7, wherein the zinc-containing anode consists of about 46.28 wt. % of zinc powder, about 24.12 wt. % of ZnO, about 28.2 wt. % of the electrolyte, and about 1.4 wt% of carboxymethyl cellulose. AMENDMENTS TO THE CLAIMS The listing of claims will replace all prior versions, and listings, of claims in the application:

Listing of claims:

1. A secondary zinc-air battery comprising at least two secondary zinc-air electrochemical cells, each cell comprising:
- an air cathode, which is a bifunctional air electrode (BAE);
- a zinc-containing anode comprising a zinc active material and an electrolyte;
- at least one first separator;
- a free electrolyte contained in a reservoir; and
- at least one second separator;
wherein the zinc-containing anode is disposed between the BAE and the free electrolyte, and is separated from the BAE by the at least one first separator and separated from the free electrolyte by the at least one second separator, and wherein the at least two cells are assembled together in such a way that a unique electrolyte reservoir is placed between at least two zinc anodes and thus is shared by the at least two secondary zinc-air electrochemical cells.

2. The secondary zinc-air battery of claim 1, wherein the weight ratio of free electrolyte in the reservoir:zinc active material is from 0.05:1 to 1:1.

3. The secondary zinc-air electrochemical battery of claim 1 claim 1 or 2, wherein the zinc active material is a mixture of metallic zinc powder and ZnO.

4. The secondary zinc-air cicctrochcmical battery of claim 1 or 3, wherein the electrolyte is an aqueous solution comprising from 0.1 M to 15 M KOH, from 0 M to 6 M KF, from 0 M to 6 M K 2 CO 3 , and from 0 M ZnO to saturation with ZnO. (Currently Amended) The secondary zinc-air cicctrochcmical battery of claim 1 or 3, wherein the electrolyte is an aqueous solution comprising about 7 M of KOH, about 1.4 M of KF, about 1.4 M of K 2 CO 3 , and ZnO until saturation.

6. The secondary zinc-air electrochemical battery of claim 1 any one of claims 1 to 5, wherein the zinc-containing anode is a zinc paste comprising from 50 wt. % to 90 wt. % of zinc powder, from 10 wt. % to 50 wt. % of ZnO, from 10 wt. % to 40 wt. % of the electrolyte, and from 0.1 wt. % to 10 wt. % of carboxymethyl cellulose.

7. The secondary zinc-air cicctrochcmical battery of claim 6, wherein the zinc powder contains bismuth traces, indium traces, aluminium traces, or mixtures thereof.

8. The secondary zinc-air cicctrochcmical battery of claim 6 claim 6 or 7, wherein the zinc-containing anode consists of about 46.28 wt. % of zinc powder, about 24.12 wt. % of ZnO, about 28.2 wt. % of the electrolyte, and about 1.4 wt% of carboxymethyl cellulose.

9. The secondary zinc-air battery of claim 7, wherein the zinc-containing anode consists of about 46.28 wt. % of zinc powder, about 24.12 wt. % of ZnO, about 28.2 wt. % of the electrolyte, and about 1.4 wt. % of carboxymethyl cellulose. (New) The secondary zinc-air battery of claim 2, wherein the zinc active material is a mixture of metallic zinc powder and ZnO.

11. The secondary zinc-air battery of claim 10, wherein the electrolyte is an aqueous solution comprising from 0.1 M to 15 M KOH, from 0 M to 6 M KF, from 0 M to 6 M K 2 CO 3 , and from 0 M ZnO to saturation with ZnO.

12. The secondary zinc-air battery of claim 10, wherein the electrolyte is an aqueous solution comprising about 7 M of KOH, about 1.4 M of KF, about 1.4 M of K 2 CO 3 , and ZnO until saturation.

13. The secondary zinc-air battery of claim 11, wherein the zinc-containing anode is a zinc paste comprising from 50 wt. % to 90 wt. % of zinc powder, from 10 wt. % to 50 wt. % of ZnO, from 10 wt. % to 40 wt. % of the electrolyte, and from 0.1 wt. % to 10 wt. % of carboxymethyl cellulose.

14. The secondary zinc-air battery of claim 13, wherein the zinc powder contains bismuth traces, indium traces, aluminium traces, or mixtures thereof. (New) The secondary zinc-air battery of claim 14, wherein the zinc-containing anode consists of about 46.28 wt. % of zinc powder, about 24.12 wt. % of ZnO, about 28.2 wt. % of the electrolyte, and about 1.4 wt. % of carboxymethyl cellulose.
